(19) United States
(12) Patent Application Publication
(10) Pub. No.: US 2023/0195886 A1
(43) Pub. Date: Jun. 22, 2023

(54) METHOD AND APPARATUS FOR SECURING INDIRECT FUNCTION CALL

(71) Applicant: ELECTRONICS AND TELECOMMUNICATIONS RESEARCH INSTITUTE, Daejeon (KR)

(72) Inventors: Gae-Il AN, Daejeon (KR); Dong-Wook KANG, Daejeon (KR); Bo-Heung CHUNG, Daejeon (KR); Hong-Il JU, Daejeon (KR); Byeong-Cheol CHOI, Daejeon (KR)

(73) Assignee: ELECTRONICS AND TELECOMMUNICATIONS RESEARCH INSTITUTE, Daejeon (KR)

(21) Appl. No.: 17/849,960

(22) Filed: Jun. 27, 2022

(30) Foreign Application Priority Data
Dec. 21, 2021 (KR) 10-2021-0183848

(51) Int. Cl. G06F 21/54

(52) U.S. Cl. CPC G06F 21/54; G06F 2221/033

(57) ABSTRACT

Disclosed herein is a method for securing an indirect function call according to an embodiment of the present invention. The method may include searching for an instruction that indirectly calls a function in intermediate representation code, calculating the number of functions that have to be allowed to be indirectly called based on the found instruction, identifying the address of a function loaded at the N-th lowest address arbitrarily set in advance, among the functions, the number of which is calculated, identifying indexes for selecting callee functions to be indirectly called based on the found instruction, determining whether to allow the function to be called using the identified indexes, and determining, when the function is allowed to be called, whether to allow the function to be called using the address of a callee function, the memory address of which is N-th lowest, among the callee functions.

### CROSS REFERENCE TO RELATED APPLICATION

This application claims the benefit of Korean Patent Application No. 10-2021-0183848, filed Dec. 21, 2021, which is hereby incorporated by reference in its entirety into this application.

### BACKGROUND OF THE INVENTION

### 1. Technical Field

The present invention relates generally to a method for securing an indirect function call, and more particularly to an indirect-function-call securing method and apparatus having improved program execution performance and security.

### 2. Description of the Related Art

Generally, function call methods in computer software may be categorized as direct calls and indirect calls. In the case of a direct call method, because the address of the function to be called is directly written in program execution code and because the code area in which the execution code is stored is protected, the address of the function to be called is not changed during execution of the program. In the case of an indirect call method, because the address of the function to be called is assigned to a variable in a data area and because the variable can be changed during execution of the program, there is a problem of vulnerability to security issues. For example, an attacker may change the control flow of the indirect call of the function through a hijacking attack such that a function desired by the attacker can be performed.

In order to prevent this problem, security code through which the integrity of the control flow for an indirect function call can be checked is directly inserted into intermediate representation code or assembly code using a Control Flow Integrity (CFI) checking method.

Control flow integrity (CFI) checking techniques include an ID-based CFI checking technique and a type-based CFI checking technique.

The ID-based CFI checking technique is a method of assigning IDs, which are identifiers, to all legitimate functions executable by an indirect function call and allowing the indirect function call only when the assigned ID is the same as the ID of the function to be executed by the function call. The type-based CFI checking technique is a method of setting type IDs for all functions and allowing a function call only when the type of the function to be executed by an indirect function call is the same as the type of a function executable by an indirect function call.

However, in the case of the ID-based CFI checking technique, as the number of legitimate functions executable by an indirect function call increases, the number of instructions that have to be inserted in order to check IDs also increases in proportion thereto, which causes a problem of degradation in program execution performance.

Also, in the case of the type-based CFI checking technique, when the type of the called function is the same as the type of a legitimate function, a function that should not be executed is allowed to be called, which causes a problem of reduced security.

### SUMMARY OF THE INVENTION

An object of the present invention is to provide a method and apparatus for securing an indirect function call in order to protect indirect function calls from a hijacking attack.

Another object of the present invention is to provide an indirect-function-call securing method and apparatus having excellent program execution performance and improved security performance.

In order to accomplish the above objects, a method for securing an indirect function call according to the present invention may include searching for an instruction that indirectly calls a function in intermediate representation code, calculating the number of functions that have to be allowed to be indirectly called based on the found instruction, identifying the address of a function loaded at the N-th lowest memory address arbitrarily set in advance, among the functions, the number of which is calculated, identifying indexes for selecting callee functions to be indirectly called based on the found instruction, determining whether to allow the function to be called using the identified indexes, and when the function is allowed to be called, determining whether to allow the function to be called using the address of a callee function, the memory address of which is N-th lowest, among the callee functions.

Calculating the number of functions may include selecting a memory storing a code area address when an instruction including the code area address is found, identifying the functions that have to be allowed to be indirectly called in the selected memory, and calculating the number of identified functions.

Identifying the indexes may include, when an instruction for selecting the address of a callee function is found, identifying a memory storing an index for selecting the callee function.

When the instruction is not found, searching for an instruction including an argument of the same call type as the call type of the function may be performed.

Determining whether to allow the function to be called using the identified indexes may include determining whether to allow the function to be called by comparing the index of the callee function with the number of functions, generating an instruction for performing a function for disallowing a call of the function when it is determined that the function is not allowed to be called, and inserting the generated instruction into the intermediate representation code.

When the index of the callee function is less than 0, it may be determined that the function is not allowed to be called.

When the index of the callee function is equal to or greater than the number of functions, it may be determined that the function is not allowed to be called.

Determining whether to allow the function to be called using the address of the callee function, the memory address of which is N-th lowest, may include identifying the callee function, the memory address of which is N-th lowest, among the callee functions, comparing the address of the identified callee function with the address of the function loaded at the N-th lowest memory address, generating an instruction for performing a function for disallowing a call of the function when the address of the identified callee function is different from the address of the function loaded at the N-th lowest memory address, and inserting the generated instruction into the intermediate representation code.

Also, an apparatus for securing an indirect function call according to the present invention may include an indirect call instruction search unit for searching for an instruction that indirectly calls a function in intermediate representation code, a function number calculation unit for calculating the number of functions that have to be allowed to be indirectly called based on the found instruction, a function address identification unit for identifying the address of a function loaded at the N-th lowest memory address arbitrarily set in advance, among the functions, the number of which is calculated, a callee function index identification unit for identifying indexes for selecting callee functions to be indirectly called based on the found instruction, a first function call allowance determination unit for determining whether to allow the function to be called using the identified indexes, and a second function call allowance determination unit for determining, when the function is allowed to be called, whether to allow the function to be called using the address of a callee function, the memory address of which is N-th lowest, among the callee functions.

The function number calculation unit may select a memory storing a code area address when an instruction including the code area address is found, identify the functions that have to be allowed to be indirectly called in the selected memory, and calculate the number of identified functions.

When an instruction for selecting the address of a callee function is found, the callee function index identification unit may identify a memory storing an index value for selecting the callee function.

When the instruction is not found, the callee function index identification unit may search for an instruction including an argument of the same type as the type of the callee function.

The first function call allowance determination unit may determine whether to allow the function to be called by comparing the index of the callee function with the number of functions, generate an instruction for performing a function for disallowing a call of the function when it is determined that the function is not allowed to be called, and insert the generated instruction into the intermediate representation code.

When the index of the callee function is less than 0, the first function call allowance determination unit may determine to disallow the call of the function.

When the index of the callee function is equal to or greater than the number of functions, the first function call allowance determination unit may determine to disallow the call of the function.

The second function call allowance determination unit may identify the callee function, the memory address of which is N-th lowest, among the callee functions, compare the address of the identified callee function with the address of the function loaded at the N-th lowest memory address, generate an instruction for performing a function for disallowing a call of the function when the address of the identified callee function is different from the address of the function loaded at the N-th lowest memory address, and insert the generated instruction into the intermediate representation code.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flowchart illustrating a method for securing an indirect function call according to an embodiment of the present invention;

FIG. 2 is a flowchart illustrating a sub-step of calculating the number of functions according to an embodiment of the present invention;

FIG. 3 is a flowchart illustrating a sub-step of identifying an index according to an embodiment of the present invention;

FIG. 4 is a flowchart illustrating a sub-step of determining whether to allow a function to be called using an index according to an embodiment of the present invention;

FIG. 5 is a flowchart illustrating a sub-step of determining whether to allow a function to be called using a callee function according to an embodiment of the present invention;

FIG. 6 is a block diagram illustrating an apparatus for securing an indirect function call according to an embodiment of the present invention;

FIG. 7 is a block diagram illustrating a compiler structure according to an embodiment of the present invention;

FIG. 8 is a block diagram illustrating a memory structure according to an embodiment of the present invention; and

FIG. 9 is a block diagram illustrating the configuration of a computer system according to an embodiment of the present invention.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only, and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

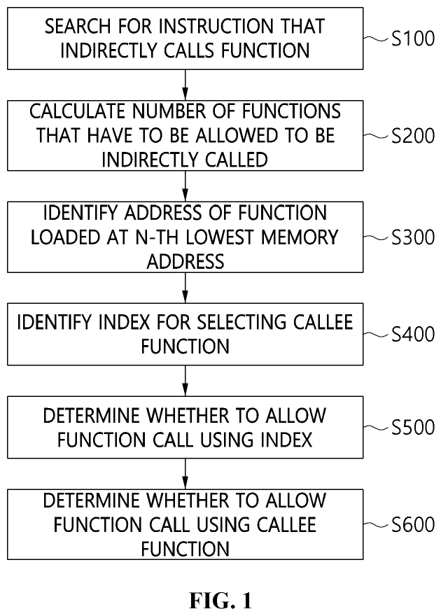

FIG. 1 is a flowchart illustrating a method for securing an indirect function call according to an embodiment of the present invention.

Referring to FIG. 1, in the method for securing an indirect function call according to an embodiment, searching for an instruction that indirectly calls a function at step S100, calculating the number of functions that have to be allowed to be indirectly called at step S200, identifying the address of the function loaded at the N-th lowest memory address at step S300, identifying an index for selecting a callee function at step S400, determining whether to allow the function to be indirectly called using the index at step S500, and determining whether to allow the function to be indirectly called using the callee function at step S600 may be performed. Here, the method for securing an indirect function call may be performed by an apparatus for securing an indirect function call, which will be described later.

The method for securing an indirect function call according to an embodiment may be applied to the middle end of a compiler. In the middle end, code optimization may be performed by interpreting intermediate representation code. The intermediate representation code may be generated after syntax checking, such as lexical analysis, syntactic analysis, semantic analysis, and the like, is performed on the received source code.

At step S100, the apparatus for securing an indirect function call may search for an instruction that indirectly calls a function in the intermediate representation code.

At step S200, the apparatus for securing an indirect function call may identify functions that have to be allowed to be called by an indirect function call (that is, legitimate functions), and may calculate the number of identified functions.

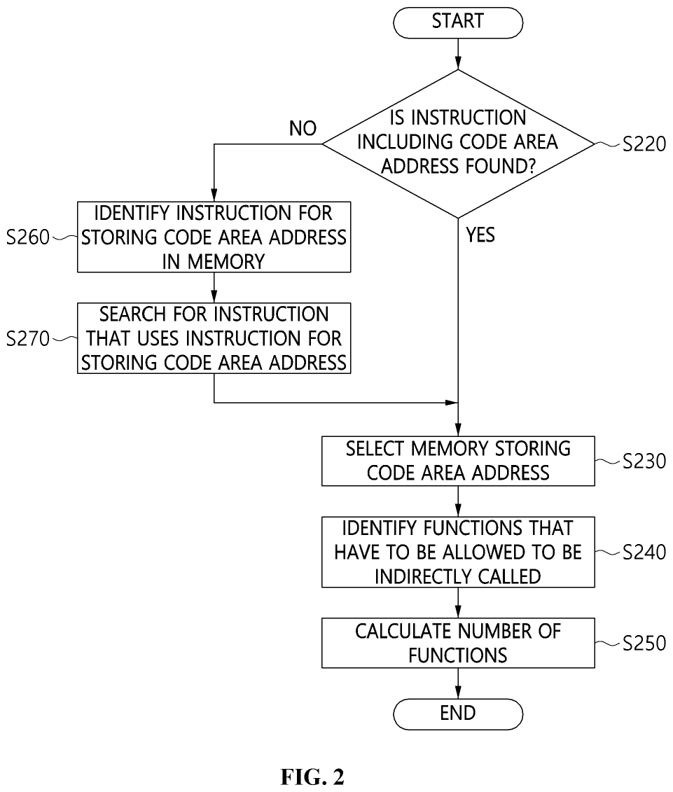

FIG. 2 is a flowchart illustrating a sub-step of calculating the number of functions according to an embodiment of the present invention.

Referring to FIG. 2, first, when an instruction including a code area address is found at step S220, the memory storing the code area address may be selected at step S230. Here, because the selected memory points to information about structure data configured with function addresses defined by a programmer, functions that have to be allowed to be called may be identified by analyzing the structure data at step S240. Then, the number of identified functions may be calculated at step S250.

Conversely, when an instruction including a code area address is not found, this indicates that the code area address is assigned to a local variable. Accordingly, an instruction for storing the code area address in stack area or heap area memory is identified at step S260, and the memory storing the code area address may be retrieved from an instruction using the identified instruction at step S270.

Referring back to FIG. 1, at step S300, the apparatus for securing an indirect function call may identify the address of the function loaded at the N-th lowest memory address, among the functions to be called by indirect function calls. The address of the function may be used in order to check whether the address is the same as the address of the callee function, which will be described later.

At step S400, the apparatus for securing an indirect function call may identify an index for selecting a callee function.

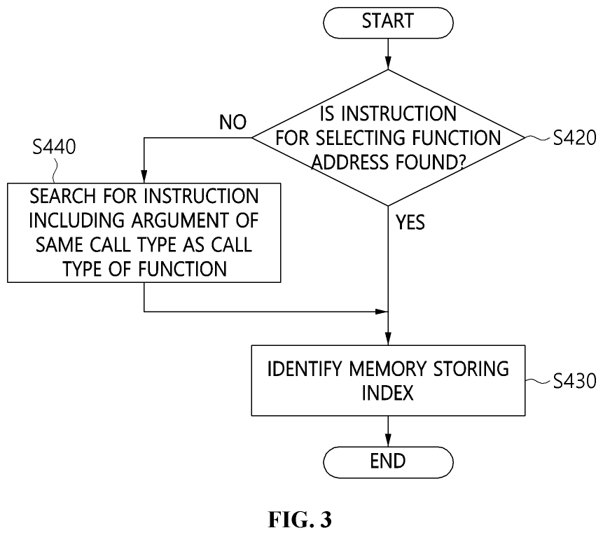

FIG. 3 is a flowchart illustrating a sub-step for identifying an index according to an embodiment of the present invention.

Referring to FIG. 3, when an instruction that selects the address of a callee function is found at step S420, the memory storing indexes for selecting callee functions is identified at step S430, whereby step S400 may be performed. For example, the instruction may be ‘getelementptr’, which is instruction code used in the compiler of LLVM.

Conversely, when an instruction that selects the address of a callee function is not found, an instruction including an argument of the same call type as the call type of the function may be searched for at step S440.

When the instruction including an argument of the same call type as the call type of the function is found, identifying the memory storing the indexes may be performed at step S430.

Referring back to FIG. 1, at step S550, the apparatus for securing an indirect function call may determine whether to allow the function to be called using the index.

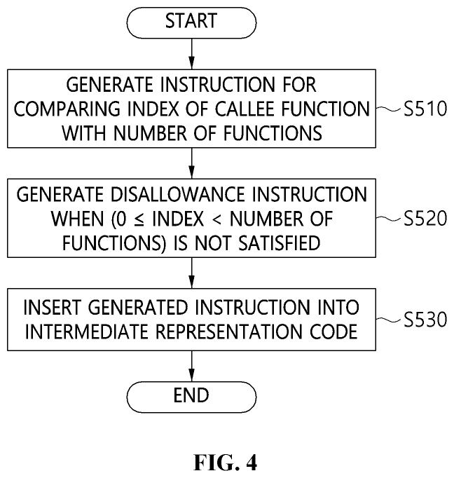

FIG. 4 is a flowchart illustrating a sub-step for determining whether to allow a function to be called using an index according to an embodiment of the present invention.

Referring to FIG. 4, first, an instruction for comparing the index of a callee function with the number of functions may be generated at step S510. When the value of the index is less than 0 or when the value of the index is equal to or greater than the number of functions, an instruction for disallowing the indirect call of the function may be generated at step S520. Then, the generated instruction may be inserted into the intermediate representation code at step S530.

Referring back to FIG. 1, at step S600, the apparatus for securing an indirect function call compares the address of the callee function, the memory address of which is N-th lowest, among the callee functions, with the address of the function loaded at the N-th lowest memory address, thereby determining whether to allow the function to be called.

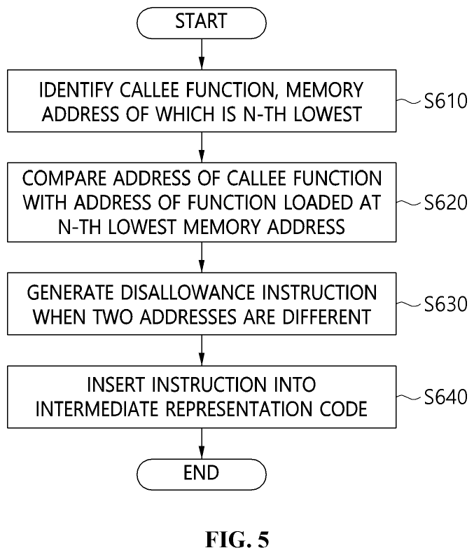

FIG. 5 is a flowchart illustrating a sub-step for determining whether to allow a function to be called using a callee function according to an embodiment of the present invention.

Referring to FIG. 5, first, a callee function, the memory address of which is N-th lowest, among callee functions, may be identified at step S610. The address of the callee function may be compared with the address of the function loaded at the N-th lowest memory address in order to check whether the two addresses are the same as each other at step S620. When the address of the callee function is not the same as the address of the function, an instruction for performing a function for disallowing the indirect call of the function may be generated at step S630. Then, the generated instruction may be inserted into the intermediate representation code at step S640.

Hereinafter, the configuration of an apparatus for securing an indirect function call, which performs a method for securing an indirect function call, will be described.

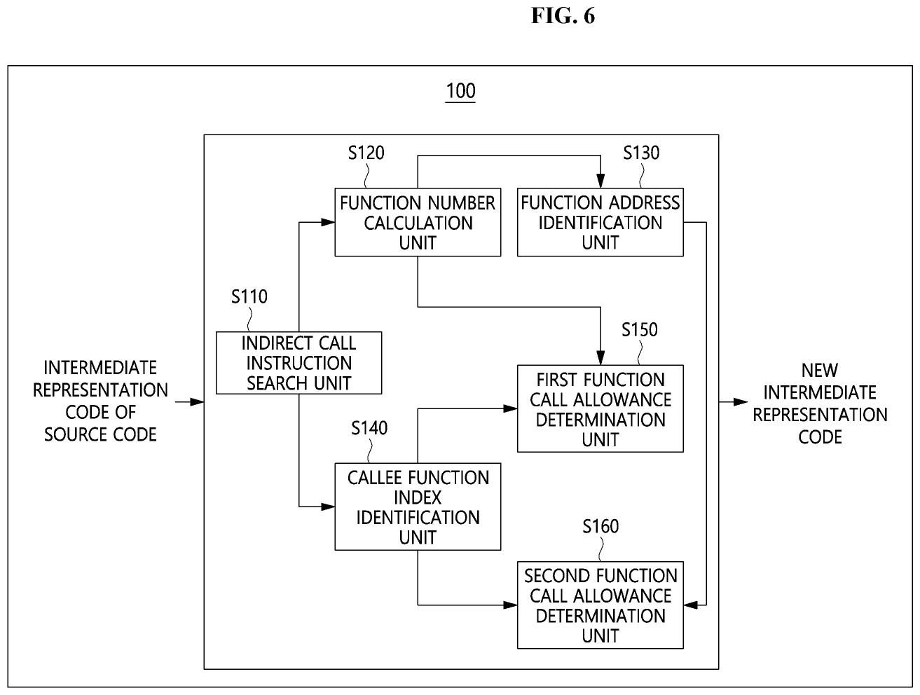

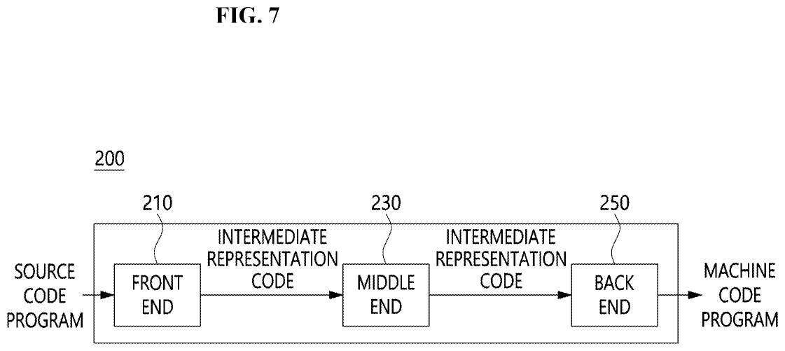

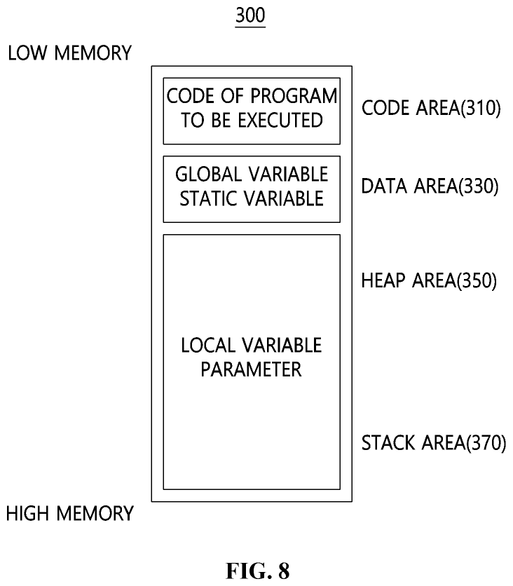

FIG. 6 is a block diagram illustrating an apparatus for securing an indirect function call according to an embodiment of the present invention, FIG. 7 is a block diagram illustrating a compiler structure according to an embodiment of the present invention, and FIG. 8 is a block diagram illustrating a memory structure according to an embodiment of the present invention.

Referring to FIG. 6, the apparatus 100 for securing an indirect function call according to an embodiment may include an indirect call instruction search unit 110, a function number calculation unit 120, a function address identification unit 130, a callee function index identification unit 140, a first function call allowance determination unit 150, and a second function call allowance determination unit 160.

Referring to FIG. 7, a compiler 200 may convert one or more blocks of source code into computer-readable machine code. For example, the machine code includes functions required for execution of an executable file.

The compiler 200 may be configured with a front end 210, a middle end 230, and a back end 250. The front end 210 may receive source code, perform syntax checking, such as lexical analysis, syntactic analysis, semantic analysis, and the like, and generate an intermediate representation code. The middle end 230 interprets the intermediate representation code, thereby performing a code optimization function. The back end 250 may generate machine code suitable for a target system by receiving the intermediate representation code.

An embodiment may be applied to the middle end 230 of the compiler 200 in order to defend against a hijacking attack on the control flow for an indirect call.

Referring to FIG. 8, the memory 300 may be an area in which an Operating System (OS) for executing a program is provided. The program code may be allocated in a code area 310 at the n-th lowest address. Global variables and static variables may be allocated in a data area 330. Local variables and parameters may be allocated in a heap area 350 or a stack area 370.

Accordingly, a function to perform an indirect call is located at an address in the code area 310. Also, the address of a callee function may be assigned to a global variable or a local variable.

Referring back to FIG. 6, the indirect call instruction search unit 110 may search for an instruction that indirectly calls a function in the intermediate representation code.

The function number calculation unit 120 may select the memory storing a code area address when an instruction including the code area address is found. The function number calculation unit 120 may identify functions that have to be allowed to be indirectly called in the selected memory, and may calculate the number of identified functions.

The function address identification unit 130 may identify the address of the function loaded at the N-th lowest memory address, which has been arbitrarily set in advance, among the functions, the number of which is calculated.

The callee function index identification unit 140 may identify the memory storing an index value for selecting a callee function when an instruction that selects a callee function address is found. Conversely, when such an instruction is not found, an instruction including an argument of the same type as the type of the callee function may be searched for.

The first function call allowance determination unit 150 may determine whether to allow a function call by comparing the index of the callee function with the number of functions. When it is determined that the function is not allowed to be called, the first function call allowance determination unit 150 may generate an instruction for performing a function for disallowing the call of the function. The first function call allowance determination unit 150 may insert the generated instruction into the intermediate representation code. Here, the first function call allowance determination unit 150 may determine to disallow the call of the function when the index of the callee function is less than 0 or when the index of the callee function is equal to or greater than the number of functions.

The second function call allowance determination unit 160 may identify a callee function, the memory address of which is N-th lowest, among callee functions. The second function call allowance determination unit 160 may compare the address of the identified callee function with the address of the function loaded at the N-th lowest memory address. The second function call allowance determination unit 160 may generate an instruction for performing a function for disallowing the call of the function when the address of the identified callee function is different from the address of the function loaded at the N-th lowest memory address. The second function call allowance determination unit 160 may insert the generated instruction into the intermediate representation code.

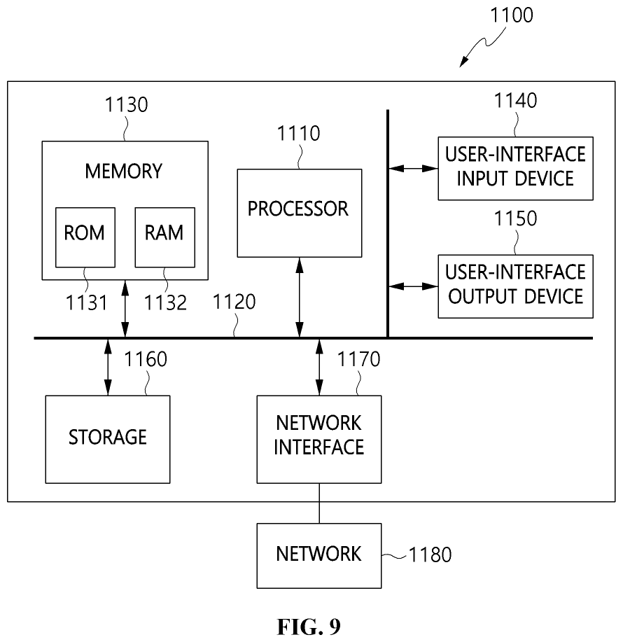

FIG. 9 is a block diagram illustrating the configuration of a computer system according to an embodiment of the present invention.

The apparatus for securing an indirect function call according to an embodiment may be implemented in a computer system 1000 including a computer-readable recording medium.

Referring to FIG. 9, the computer system 1000 according to an embodiment may include one or more processors 1010, memory 1030, a user-interface input device 1040, a user-interface output device 1050, and storage 1060, which communicate with each other via a bus 1020. Also, the computer system 1000 may further include a network interface 1070 connected to a network.

The processor 1010 may be a central processing unit or a semiconductor device for executing a program or processing instructions stored in the memory or the storage. The memory 1030 and the storage 1060 may be storage media including at least one of a volatile medium, a nonvolatile medium, a detachable medium, a non-detachable medium, a communication medium, and an information delivery medium. For example, the memory 1030 may include ROM 1031 or RAM 1032.

The processor 1010 may include instructions for performing a method including an operation for searching for an instruction that indirectly calls a function in intermediate representation code, an operation for calculating the number of functions that have to be allowed to be indirectly called based on the found instruction, an operation for identifying the address of the function loaded at the N-th lowest memory address, among the functions, the number of which is calculated, an operation for identifying an index for selecting a callee function to be indirectly called based on the found instruction, an operation for determining whether to allow the function to be called using the identified index, and an operation for determining, when the function is allowed to be called, whether to allow the function to be called using the address of the callee function, the memory address of which is N-th lowest, among the callee functions.

The present invention may improve program execution performance because the number of instructions that have to be inserted into intermediate representation code is fixed.

Also, the present invention may improve security performance because functions other than functions that have to be executed are not allowed to be called.

As described above, the method and apparatus for securing an indirect function call according to the present invention are not limitedly applied to the configurations and operations of the above-described embodiments, but all or some of the embodiments may be selectively combined and configured, so the embodiments may be modified in various ways.

What is claimed is:

1. A method for securing an indirect function call, comprising:
searching for an instruction that indirectly calls a function in intermediate representation code;
calculating a number of functions that have to be allowed to be indirectly called based on the found instruction;
identifying an address of a function loaded at an N-th lowest memory address, among the functions, the number of which is calculated;
identifying indexes for selecting callee functions to be indirectly called based on the found instruction;
determining whether to allow the function to be called using the identified indexes; and
when the function is allowed to be called, determining whether to allow the function to be called using an address of a callee function, a memory address of which is N-th lowest, among the callee functions.

2. The method of claim 1, wherein calculating the number of functions includes
selecting a memory storing a code area address when an instruction including the code area address is found;
identifying the functions that have to be allowed to be indirectly called in the selected memory; and
calculating the number of identified functions.

3. The method of claim 1, wherein identifying the indexes comprises, when an instruction for selecting an address of a callee function is found, identifying a memory storing an index for selecting the callee function, thereby identifying the indexes.

4. The method of claim 3, wherein, when the instruction is not found, an instruction including an argument of a same call type as a call type of the function is searched for.

5. The method of claim 1, wherein determining whether to allow the function to be called using the identified indexes includes
comparing the index of the callee function with the number of functions and determining whether to allow the function to be called;
generating an instruction for performing a function for disallowing a call of the function when it is determined that the function is not allowed to be called; and
inserting the generated instruction into the intermediate representation code.

6. The method of claim 5, wherein, when the index of the callee function is less than 0, it is determined that the function is not allowed to be called.

7. The method of claim 5, wherein, when the index of the callee function is equal to or greater than the number of functions, it is determined that the function is not allowed to be called.

8. The method of claim 1, wherein determining whether to allow the function to be called using the address of the callee function, the memory address of which is N-th lowest, includes
identifying the callee function, the memory address of which is N-th lowest, among the callee functions;
comparing the address of the identified callee function with the address of the function loaded at the N-th lowest memory address;
generating an instruction for performing a function for disallowing a call of the function when the address of the identified callee function is different from the address of the function loaded at the N-th lowest memory address; and
inserting the generated instruction into the intermediate representation code.

9. An apparatus for securing an indirect function call, comprising:
an indirect call instruction search unit for searching for an instruction that indirectly calls a function in intermediate representation code;
a function number calculation unit for calculating a number of functions that have to be allowed to be indirectly called based on the found instruction;
a function address identification unit for identifying an address of a function loaded at an N-th lowest memory address, among the functions, the number of which is calculated;
a callee function index identification unit for identifying indexes for selecting callee functions to be indirectly called based on the found instruction;
a first function call allowance determination unit for determining whether to allow the function to be called using the identified indexes; and
a second function call allowance determination unit for determining, when the function is allowed to be called, whether to allow the function to be called using an address of a callee function, a memory address of which is N-th lowest, among the callee functions.

10. The apparatus of claim 8, wherein the function number calculation unit selects a memory storing a code area address when an instruction including the code area address is found, identifies the functions that have to be allowed to be indirectly called in the selected memory, and calculates the number of identified functions.

11. The apparatus of claim 9, wherein, when an instruction for selecting an address of a callee function is found, the callee function index identification unit identifies a memory storing an index value for selecting the callee function.

12. The apparatus of claim 11, wherein, when the instruction is not found, the callee function index identification unit searches for an instruction including an argument of a same type as a type of the callee function.

13. The apparatus of claim 9, wherein the first function call allowance determination unit determines whether to allow the function to be called by comparing the index of the callee function with the number of functions, generates an instruction for performing a function for disallowing a call of the function when it is determined that the function is not allowed to be called, and inserts the generated instruction into the intermediate representation code.

14. The apparatus of claim 13, wherein, when the index of the callee function is less than 0, the first function call allowance determination unit determines to disallow the call of the function.

15. The apparatus of claim 13, wherein, when the index of the callee function is equal to or greater than the number of functions, the first function call allowance determination unit determines to disallow the call of the function.

16. The apparatus of claim 9, wherein the second function call allowance determination unit identifies the callee function, the memory address of which is N-th lowest, among the callee functions, compares the address of the identified callee function with the address of the function loaded at the N-th lowest memory address, generates an instruction for performing a function for disallowing a call of the function when the address of the identified callee function is different from the address of the function loaded at the N-th lowest memory address, and inserts the generated instruction into the intermediate representation code.
